(19) United States
(12) Patent Application Publication
(10) Pub. No.: US 2011/0178613 A9
(43) Pub. Date: Jul. 21, 2011

(54) Method And System For Processing Signals For A MEMS Detector That Enables Control Of A Device Using Human Breath

(76) Inventor: Pierre Bonnat, Las Vegas, NV (US)

(21) Appl. No.: 12/056,203

(22) Filed: Mar. 26, 2008

Related U.S. Application Data
(63) Continuation-in-part of application No. 10/453,192, filed on Jun. 2, 2003, now Pat. No. 7,584,064.
Application No. 10/453,192 is a continuation of application No. 09/913,398, filed on Aug. 10, 2001, now Pat. No. 6,574,571.
(60) Provisional application No. 60/974,613, filed on Sep. 24, 2007.

(51) Int. Cl. G05B 15/02; G01D 18/00

(52) U.S. Cl. 700/83; 702/104

(57) ABSTRACT

A method and system for processing signals for a MEMS detector that enables control of a device using expulsion of air via human breath, a machine and/or a device are provided. A microprocessor may receive one or more signals from the MEMS detector that may comprise various component sensor(s), sensing member(s) or sensing segment(s) that may detect movement of air caused by the expulsion of human breath. The signals may be processed by the microprocessor and an interactive output comprising one or more control signals that may enable control of a user interface such as 107a-107e on the multimedia device 106a-106e may be generated. For each component sensor(s), sensing member(s) or sensing segment(s) in the MEMS detector, ranges or gradients may be measured and evaluated to determine which of the sensor(s), sensing member(s) or sensing segment(s) of the MEMS detector 212 may have been activated, moved or deflected.

### CROSS-REFERENCE TO RELATED APPLICATIONS/INCORPORATION BY REFERENCE

This application makes reference to, claims priority to, and claims the benefit of U.S. Provisional Application Ser. No. 60/974,613, filed on Sep. 24, 2007.

This application also makes reference to:
U.S. application Ser. No. ______ (Attorney Docket No. 19449US01 P014), which is filed on even date herewith;
U.S. application Ser. No. ______ (Attorney Docket No. 19450US01 P015), which is filed on even date herewith;
U.S. application Ser. No. ______ (Attorney Docket No. 19452US01 P017), which is filed on even date herewith;
U.S. application Ser. No. ______ (Attorney Docket No. 19453US01 P018), which is filed on even date herewith; and
U.S. application Ser. No. ______ (Attorney Docket No. 19454US01 P019), which is filed on even date herewith.

Each of the above stated applications is hereby incorporated herein by reference in its entirety.

### FIELD OF THE INVENTION

Certain embodiments of the invention relate to communication. More specifically, certain embodiments of the invention relate to a method and system for processing signals for a MEMS detector that enables control of a device using human breath.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology.

While voice connections fulfill the basic need to communicate, and mobile voice connections continue to filter even further into the fabric of every day life, the mobile access to services via the Internet has become the next step in the mobile communication revolution. Currently, most mobile devices are equipped with a user interface that allows users to access the services provided via the Internet. For example, some mobile devices may have browsers, software, and/or hardware buttons may be provided to enable navigation and/or control of the user interface. Some mobile devices such as Smartphones are equipped with touch screen capability that allows users to navigate or control the user interface via touching with one hand while the device is held in another hand.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method is provided for processing signals for a MEMS detector that enables control of a device using human breath, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for controlling a user interface of a plurality of devices using human breath, in accordance with an embodiment of the invention.

FIG. 2 is a block diagram of an exemplary MEMS sensing and processing module, in accordance with an embodiment of the invention.

FIG. 3 is a flow chart that illustrates exemplary steps for providing human media interaction for a MEMS sensing and processing module, in accordance with an embodiment of the invention.

FIG. 4 is a flow chart that illustrates exemplary steps for sensor reading and cycling of a breath-sensitive sensor embedded in a MEMS sensing and processing module, in accordance with an embodiment of the invention.

FIG. 5 is a flow chart that illustrates exemplary steps for sensor calibration in a MEMS sensing and processing module, in accordance with an embodiment of the invention.

FIG. 6 is a flow chart that illustrates exemplary steps for determining valid input in a MEMS sensing and processing module, in accordance with an embodiment of the invention.

FIG. 7 is a flow chart that illustrates exemplary steps for determining behavior output in a MEMS sensing and processing module, in accordance with an embodiment of the invention.

FIG. 8 is a flow chart that illustrates exemplary steps for human interaction of a wireless MEMS sensing and processing module, in accordance with an embodiment of the invention.

### DETAILED DESCRIPTION OF THE INVENTION

Certain embodiments of the invention may be found in a method and system for processing signals for a MEMS detector that enables control of a device using expulsion of air via, for example, human breath, a machine or a device are provided. A microprocessor may receive one or more signals from the MEMS detector that may comprise one or more various component sensors, sensing members or sensing segments that may be enabled to detect movement of air caused by the expulsion of human breath, for example. The signals may be processed by the microprocessor and an interactive output comprising one or more control signals that may enable control of a user interface such as 107a-107e on the devices 106a-106e may be generated. For each component sensor, sensing member or sensing segment in the MEMS detector, ranges or gradients may be measured and evaluated to determine which of the one or more sensors, sensing member or sensing segments of the MEMS detector 212 may have been activated, moved or deflected. In accordance with an embodiment of the invention, the received signals may be formatted to be human interface device (HID) profile compliant. The formatted control signals may be communicated to the devices 106a-1 06e via a wired and/or wireless medium.

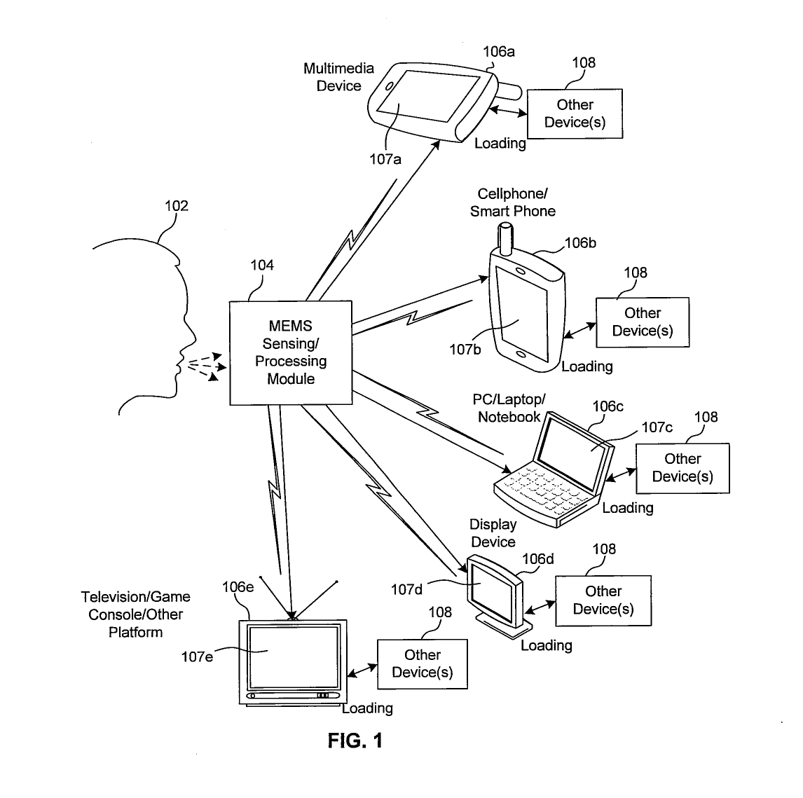

FIG. 1 is a block diagram of an exemplary system for controlling a user interface of a plurality of devices using human breath, in accordance with an embodiment of the invention. Referring to FIG. 1, there is shown a user 102, a micro-electro-mechanical system (MEMS) sensing and processing module 104, and a plurality of devices to be controlled, such as a multimedia device 106a, a cellphone/smartphone/dataphone 106b, a personal computer (PC), laptop or a notebook computer 106c, a display device 106d and/or a television (TV)/game console/other platform 106e. The multimedia device 106a may comprise a user interface 107a, the cellphone/smartphone/dataphone 106b may comprise a user interface 107b, and the personal computer (PC), laptop or a notebook computer 106c may comprise a user interface 107c. Additionally, the display device 106d may comprise a user interface 107d and the television (TV)/game console/other platform 106e may comprise a user interface 107e. Each of the plurality of devices to be controlled may be wired or wirelessly connected to a plurality of other devices 108 for loading of information, for example via side loading, and/or communication of information, for example, peer-to-peer and/or network communication.

The MEMS sensing and processing module 104 may be enabled to detect movement caused by expulsion of human breath by the user 102. In response to the detection of movement caused by expulsion of human breath, the MEMS sensing and processing module 104 may be enabled to generate one or more controls signals. The MEMS sensing and processing module 104 may comprise one or more sensors, sensing segments or sensing members that may be operable to sense the kinetic energy generated by the expulsion of the human breath and accordingly generate the one or more control signals. The generated one or more control signals may be enabled to control a user interface of one or more of a plurality of devices, such as the user interface 107a of the multimedia device 106a, the user interface 107b of the cellphone/smartphone/dataphone 106b, the user interface 107c of the PC, laptop or a notebook computer 106c, the user interface 107d of the display device 106d, the user interface 107e of the TV/game console/other platform 106e, and the user interfaces of the mobile multimedia player and/or a remote controller.

In accordance with an embodiment of the invention, the detection of the movement caused by expulsion of human breath may occur without use of a channel. The detection of the movement caused by expulsion of human breath may be responsive to the expulsion of human breath into open space, which is then sensed. The detection of the movement caused by expulsion of human breath may also be responsive to the expulsion of human breath on one or more devices or detectors such as the MEMS module 104, which enables the detection. U.S. application Ser. No. ______ (Attorney Docket No. 19450US01 P015) discloses an exemplary MEMS sensing and processing module and is hereby incorporated herein by reference in its entirety.

In accordance with another embodiment of the invention, the MEMS sensing and processing module 104 may be enabled to navigate within the user interface of one of more of the plurality of devices, such as a handheld device, for example, a multimedia device 106a, a cellphone/smartphone/dataphone 106b, a PC, laptop or a notebook computer 106c, a display device 106d, and/or a TV/game console/other platform 106e via the generated one or more control signals. The MEMS sensing and processing module 104 may be enabled to select one or more components within the user interface of the plurality of devices via the generated one or more control signals. The generated one or more control signals may comprise one or more of a wired and/or a wireless signal.

In accordance with another embodiment of the invention, one or more of the plurality of devices, such as a handheld device, for example, a multimedia device 106a and/or a cellphone/smartphone/dataphone 106b and/or a PC, game console, laptop or a notebook computer 106c may be enabled to receive one or more inputs defining the user interface from another device 108. The other device 108 may be one or more of a PC, game console, laptop or a notebook computer 106c and/or a handheld device, for example, and without limitation, a multimedia device 106a and/or a cellphone/smartphone/dataphone 106b. In this regard, data may be transferred from the other device 108 to the cellphone/smartphone/dataphone 106b and this data may be associated or mapped to media content that may be remotely accessed by the cellphone/smartphone/dataphone 106b via a service provider such as a cellular or PCS service provider. The transferred data that is associated or mapped to media content may be utilized to customize the user interface 107b of the cellphone/smartphone/dataphone 106b. In this regard, media content associated with one or more received inputs may become an integral part of the user interface of the device being controlled. The associating and/or mapping may be performed on either the other device 108 and/or one the cellphone/smartphone/dataphone 106b. In instances where the associating and/or mapping is performed on the other device 108, the associated and/or mapped data may be transferred from the other device 108 to the cellphone/smartphone/dataphone 106b.

In an exemplary embodiment of the invention, an icon transferred from the other device 108 to the cellphone/smartphone/dataphone 106b may be associated or mapped to media content such as an RSS feed and/or a mark language that may be remotely accessed by the cellphone/smartphone/dataphone 106b via the service provider of the cellphone/smartphone/dataphone 106b. Accordingly, when the user 102 blows on the MEMS sensing and processing module 104, control signals generated by the MEMS sensing and processing module 104 may navigate to the icon and select the icon. Once the icon is selected, the RSS feed may be accessed via the service provider of the cellphone/smartphone/dataphone 106b and corresponding RSS feed content may be displayed on the user interface 107b. U.S. application Ser. No. ______ (Attorney Docket No. 19454US01 P019) discloses an exemplary method and system for customizing a user interface of a device and is hereby incorporated herein by reference in its entirety.

In operation, a user 102 may exhale into open space and the exhaled breath may be sensed by one or more detection devices or detectors, such as one or more sensors, sensing members and/or sensing segments in the MEMS sensing and processing module 104. The MEMS sensing and processing module 104 may be enabled to detect movement caused by expulsion of human breath by the user 102. One or more electrical, optical and/or magnetic signals may be generated by one or more detection device(s) or detector(s) within the MEMS sensing and processing module 104 in response to the detection of movement caused by expulsion of human breath. The processor firmware within the MEMS sensing and processing module 104 may be enabled to process the received electrical, optical and/or magnetic signals from the one or more detection device(s) or detector(s) utilizing various algorithms and generate one or more control signals to the device being controlled, for example, the multimedia device 106a. The generated one or more control signals may be communicated to the device being controlled, for example, the multimedia device 106a via a wired and/or a wireless signal. The processor in the device being controlled may utilize the communicated control signals to control the user interface of the device being controlled, such as a user interface 107a of the multimedia device 106a, a user interface 107b of the cellphone/smartphone/dataphone 106b, a user interface 107c of the personal computer (PC), laptop or a notebook computer 106c, a user interface 107d of the display device 106d, a user interface 107e of the TV/game console/other platform 106e, and a user interface of a mobile multimedia player and/or a remote controller.

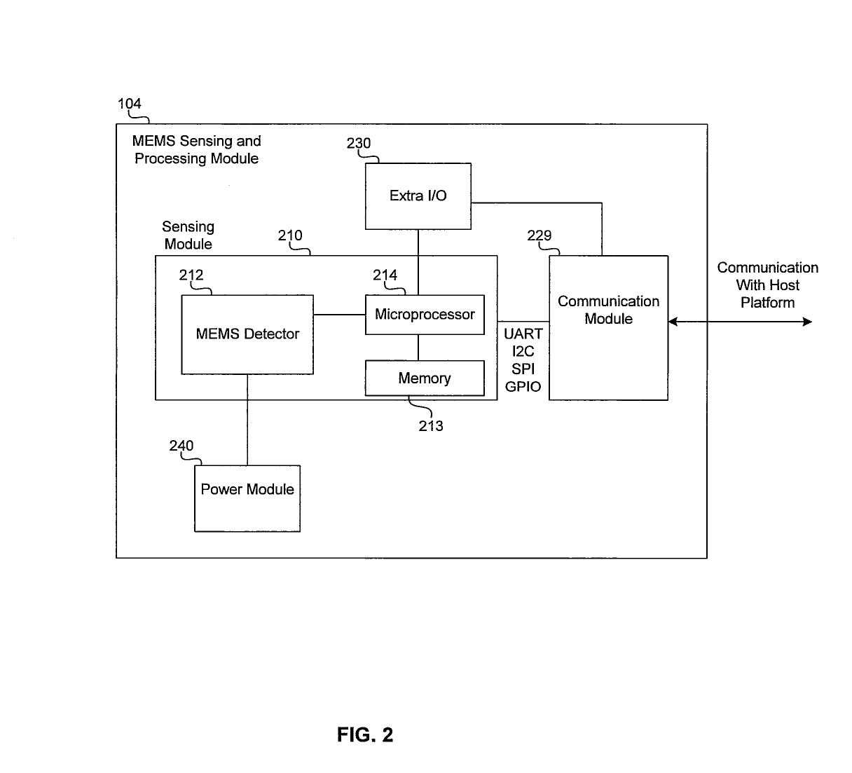

FIG. 2 is a block diagram of an exemplary MEMS sensing and processing module, in accordance with an embodiment of the invention. Referring to FIG. 2, there is shown a MEMS sensing and processing module 104. The MEMS sensing and processing module 104 may comprise a sensing module 210, a power module 240, an extra I/O module 230, and a communication module 220. The sensing module 210 may comprise a MEMS detector 212, a memory 213 and a microprocessor 214.

The sensing module 210 may comprise suitable logic, circuitry and/or code that may be capable of sensing and responding to environmental actions nearby. The sensing module 210 may enable users to interact with the devices such as the multimedia device 106a via a user interface such as a Graphic User Interface (GUI), or through dedicated software routines to run customized applications. In this regard, the sensing module 210 may enable the interaction of the users with the multimedia device 106a, among other possible software and/or applications, through human breath.

The MEMS detector 212 may be enabled to detect a change in strength, humidity and/or temperature at the MEMS detector 212. The MEMS detector 212 may comprise one or more component sensors, sensing members or sensing segments mounted within the sensing module 210 to detect the difference in electrical characteristics accompanying human breath in the proximity of the component sensor(s), sensing member(s) or sensing segment(s). The component sensor(s), sensing member(s) or sensing segment(s) may be implemented in various ways such as being placed evenly in 3600 inside the MEMS detector 212. Each component sensor(s), sensing member(s) or sensing segment(s) in the MEMS detector 212 may be turned on and off at a certain frequency or may be dimmed at a certain circumstance to reduce power consumption. Accordingly, the component sensor(s), sensing member(s) or sensing segment(s) in the MEMS detector 212 may be working in various modes such as a normal interactive mode, a sleep mode or an idle mode. For example, a component sensor, sensing member or sensing segment in the MEMS detector 212 may be turned on in full power only when you may be in a full darkness. However, the component sensor(s), sensing member(s) or sensing segment(s) may be progressively dimmed as long as there may be, for example, light surrounding it to reduce device power consumption.

The microprocessor 214 may comprise suitable logic, circuitry and/or code that may be enabled to monitor the electrical characteristics of the MEMS detector 212 and process sensing information to respond intelligently to the presence of human breath. The microprocessor 214 may be mounted within the sensing module 210 and operatively connected to the MEMS detector 212. The microprocessor 214 may be capable of reading sensing data, which may be detected in a form of analog signals, and converting the detected sensing data to digital signals. When a user may whisper, speak, puff or blow breathe near the MEMS detector 212, the microprocessor 214 may calculate the difference in corresponding electrical characteristics caused by the humidity, temperature or velocity/strength of his or her breath, and may cause the MEMS sensing and processing module 104 to produce an interactive output such as some AT commands in response.

In accordance with various embodiments of the invention, due for example, to the fact that mechanical, electrical and/or electromechanical components may change over time and may deteriorate due to fatigue, condensation, humidity, for example, calibration may be required. In this regard, the microprocessor 214 may be enabled to calibrate/recalibrate the component sensor(s), sensing member(s) or sensing segment(s) in the MEMS detector 212 in various ways. For example, the microprocessor 214 may statically or dynamically calibrate the component sensor(s), sensing member(s) or sensing segment(s) selectively. For example, a component sensor, sensing member or sensing segment may be calibrated at reset or may be calibrated at every sensor cycle depending on, for example, user configuration and/or implementation. To avoid unwanted interactions, the microprocessor 214 may be operable to process only validly sensed data from each component sensor, sensing member or sensing segment. In this regard, the received sensing data from the component sensor(s), sensing member(s) or sensing segment(s) may be adjusted due to the component calibration and may be compared to a sensor specific operating curve. Sensed data in the vicinity of the sensor(s), sensing member(s) or sensing segment(s) operating curve may be validly processed for potential human interactive output. Calibration may be utilized to discard a certain portion of the range of sensing. The reflection range may be controlled using artificial intelligence (AI) techniques, for example.

The human interactive output may be intelligently determined based on the valid input data via various algorithms and/or artificial (AI) intelligence logic or routines. For example, in instances where the MEMS detector 212 may comprise 4 component sensors, sensing members or sensing segments, the valid input data may comprise information on the changes in signals simultaneously at more than three component sensors, sensing members or sensing segments, the microprocessor 214 may consider the received valid input data may be unwanted (e.g., “noise”) and may not continue to process that input signal. Artificial Intelligence logic may allow adaptation to, for example, a users' patterns and the most prominent usage patterns and/or procedures for the determining what may or may not be valid input data. A wanted or desirable interactive output may be generated based on valid input data and other information such as user configuration information. The wanted interactive output may comprise multiple forms of interaction such as selecting, scrolling, zooming, or 3D navigation. The wanted interactive output may communicated in a known format such as via UART and SPI as an input to a wired and/or a wireless communication module depending on usage requirements.

A storage device such as memory 213 may be readable and/or writable by the microprocessor 214 and may comprise instructions that may be executable by the microprocessor 214. This instruction may comprise user configuration information that may turn on one or more of the component sensor(s), sensing member(s) or sensing segment(s) of the MEMS detector 212. The instruction may enable different sets of interaction behavior and time thresholds, and may allow programmed responses of the MEMS sensing and processing module 104 so as to deliver multiple forms of interaction such as selecting, scrolling, zooming, or 3D navigation to make human media interaction as intuitive, fast, easy, natural, and/or logical.

The power module 240 may comprise suitable logic, circuitry and/or code that may enable delivery and management of power. The power module 240 may enable recharging, and/or voltage regulation. The power module 240 may comprise, for example, a rechargeable or a disposable battery.

The extra I/O module 230 may comprise suitable logic, circuitry and/or code that may comprise a plurality of associated components such as a microphone, a speaker, a display, and other additional user I/O interface.

The communication module 220 may comprise suitable logic, circuitry and/or code that may be enabled to communicate with the device platform/host through, for example, a CODEC, or wired protocol such as USB, or wireless protocol such as Bluetooth, infrared, near field communication (NFC), ultrawideband (UWB), 60 GHz or ZigBee protocols.

In operation, when the MEMS detector 212 may be turned on in a normal interactive mode, user configuration may occur and various parameters may be initialized via the extra I/O 230. For example, the user of the MEMS sensing and processing module 104 may turn on the one or more component sensor(s), sensing member(s) or sensing segment(s) of the MEMS detector 212 individually, and specify human media interaction types such as selecting, scrolling, pointing, zooming, or 3D navigation. The component sensor(s), sensing member(s) or sensing segment(s) in the MEMS detector 212 may detect a change in velocity/strength, humidity and/or temperature when the user may breathe within the proximity of the MEMS detector 212. The detected velocity/strength, humidity and/or temperature may be sensed and corresponding signals may be communicated to the microprocessor 214 in a form of analog signals. The microprocessor 214 may acquire the analog signals and convert them to corresponding digital signals.

The microprocessor 214 may calibrate the component sensor(s), sensing member(s) or sensing segment(s) by calculating the corresponding component sensor(s), sensing member(s) or sensing segment(s) ranges and may check the validity of the sensed data by, for example, percentage or raw values from the component sensor(s), sensing member(s) or sensing segment(s) in the MEMS detector 212. The MEMS detector 212 may enter a specific operating mode such as an idle mode based on the sensor(s), sensing member(s) or sensing segment(s) power status from the power module 240. Inputs detected by human breath at the component sensor(s), sensing member(s) or sensing segment(s) and user inputs from the extra I/O module 230 may be evaluated by comparing them to sensor(s), sensing member(s) or sensing segment(s) specific operating curves and/or by running various embedded algorithms and used to intelligently produce interactive output. The microprocessor 214 may communicate the interactive output in a known format such as UART and SPI to the communication module 220 such as Bluetooth or other wired and/or wireless module depending on usage requirements. The MEMS sensing and processing module 104 host or the host of its pair devices such as the multimedia device 106a may provide various software solutions to enable processing and/or communication of interaction signals. The software solution may comprise drivers, OS-libraries of functions including breath specific mapping of local functions, signal format conversion, user customized features, and integrated platform applications such as C++, Java, Flash, and other software languages. The microprocessor 214 may also output human interactive information through the extra I/O 230 when requested during user configuration.

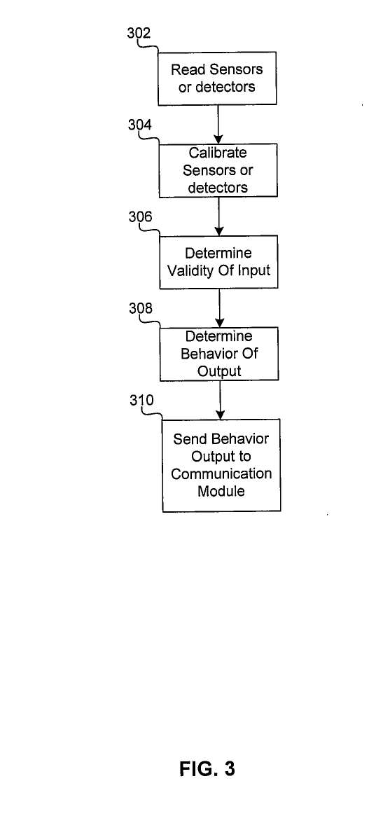

FIG. 3 is a flow chart that illustrates exemplary steps for providing human media interaction for a MEMS sensing and processing module, in accordance with an embodiment of the invention. Referring to FIG. 3, the MEMS detector 212 may be turned on in a normal interactive mode, for example, in a full power mode. In step 302, the sensors or detectors may be read. In this regard, the MEMS detector 212 may detect a change in velocity/strength, humidity and/or temperature when the user may breathe, whisper, puff air, or speak near the component sensor(s), sensing member(s) or sensing segment(s) of the MEMS detector 212. The microprocessor 214 may read the sensed data from each of the component sensor(s), sensing member(s) or sensing segment(s) in the MEMS detector 212. In step 304, the sensors or detectors may be calibrated. In this regard, the microprocessor 214 may evaluate the received sensed data and may calibrate the component sensor(s), sensing member(s) or sensing segment(s) in the MEMS detector 212 based on the received sensed data and/or configuration data stored in the memory 213. In step 306, a validity of the input may be determined. Different characteristics caused by, for example, the humidity of the user's breath, and the user inputs from the extra I/O module 230, may be calculated by running various embedded algorithms to produce responses to any differences between actual and expected input. In step 308, a behavior of the output may be determined. In this regard, the microprocessor 214 may determine an output based on results of the determination in step 306. In step 310, the microprocessor 214 may communicate output data in a known format such as UART and SPI to the communication module 220.

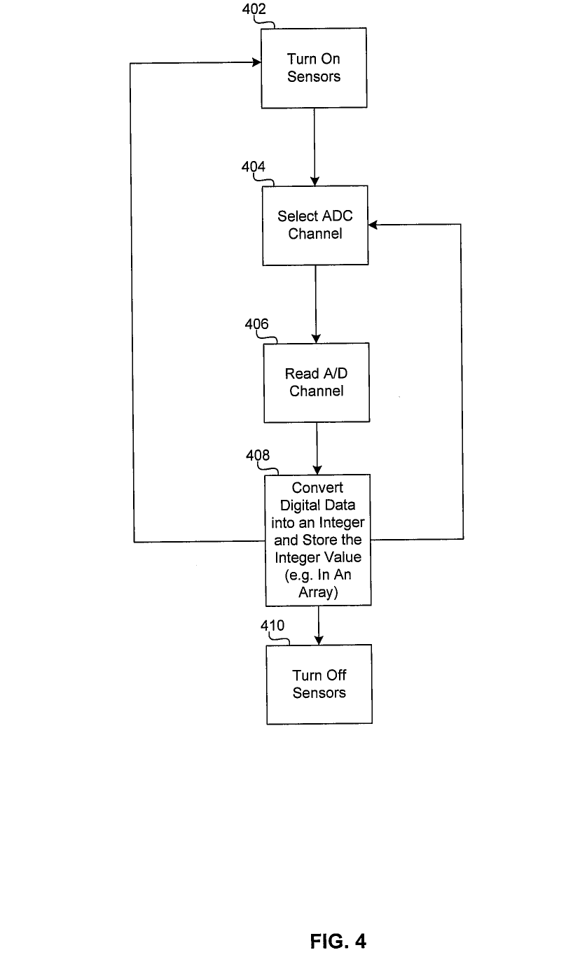

FIG. 4 is a flow chart that illustrates exemplary steps for sensor reading and cycling of a breath-sensitive sensor embedded in a MEMS sensing and processing module, in accordance with an embodiment of the invention. Referring to FIG. 4, in step 402, the component sensor(s), sensing member(s) or sensing segment(s) in the MEMS detector 212 may be turned on individually or in combination according to user configuration settings. In step 404, an ADC channel may be selected for analog-to-digital conversion of the received sensing data from a particular component sensor, sensing member or sensing segment in the MEMS detector 212. In step 406, the A/D channel may be read. In step 408, digital data may be converted into an integer and stored, for example, in an array. In instances where more component sensor(s), sensing member(s) or sensing segment(s) in the MEMS detector 212 may be available to pass sensing data to the microprocessor 214, then return to the step 404, where another sensor, sensing member or sensing segment may be read. In instances where sensed data has been acquired from each of component sensor(s), sensing member(s) or sensing segment(s) in the MEMS detector 212, the resulting digital data may be saved in a corresponding array. In step 410, after a period of time without receiving additional sensing data from the component sensor(s), sensing member(s) or sensing segment(s), the component sensor(s), sensing member(s) or sensing segment(s) may be turned off to save power. After a certain time period, the component sensor(s), sensing member(s) or sensing segment(s) may be turned on again in a normal interactive mode and step 402 may be executed. The component sensor(s), sensing member(s) or sensing segment(s) may be turned on and off at a certain frequency based on MEMS device configuration to reduce power consumption. The time period may depend on the application and may be set during the user configuration.

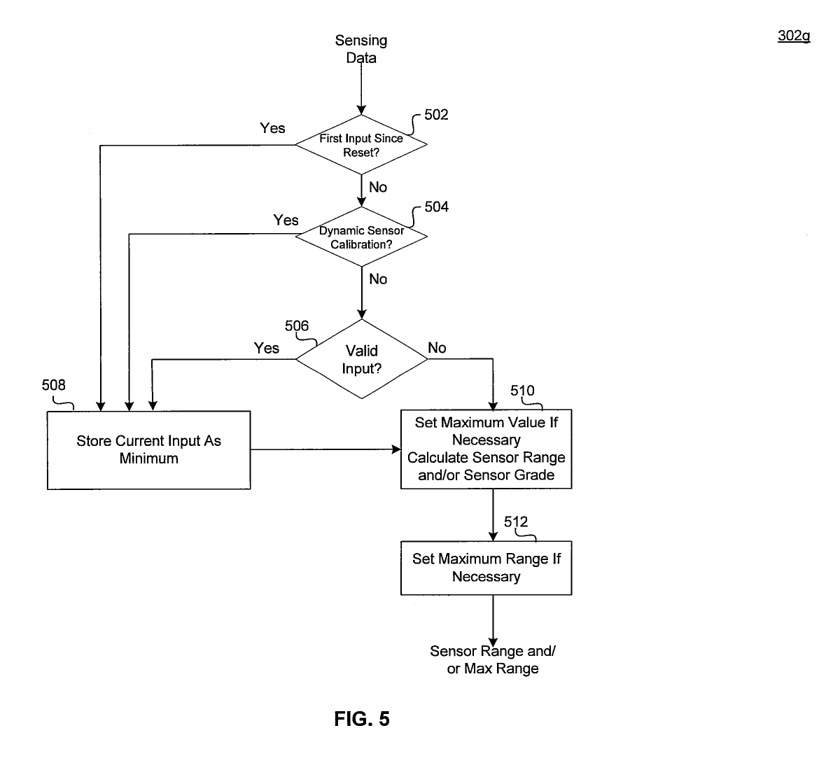

FIG. 5 is a flow chart that illustrates exemplary steps for sensor calibration in a MEMS sensing and processing module, in accordance with an embodiment of the invention. Referring to FIG. 5, a range of a component sensor, sensing member or sensing segment in the MEMS detector 212 may correspond to a change in absolute value in the sensed data detected at the component sensor, sensing member or sensing segment. In instances where sensing of data is occurring, in step 502, it may be determined whether this is the first input since a component sensor(s), sensing member(s) or sensing segment(s) reset. If this is the first input since a reset, then in step 508, the current input may be stored as the minimum value of sensing data from the component sensor. In step 510, a maximum value may be set for the sensor, sensing member or sensing segment when a maximum range may be required. The component sensor(s), sensing member(s) or sensing segment(s) range/grade may be calculated and stored. In step 512, a maximum sensor(s), sensing member(s) or sensing segment(s) range/grade may be set and stored if necessary. Depending on applications, the sensor range and/or the sensor grade may be used for sensor calibration.

Returning to step 502, if this is not the first input since a reset, then in step 504, it may be determined whether dynamic sensor calibration may be required. In step 504, in instances where a static sensor calibration may be required or needed, then the next step is step 508. In step 504, if dynamic sensor calibration may not be required, then in step 506, it may be determined whether the input may be valid. In instances where the input is valid, then the next step may be step 508. In instances where the input is invalid, then the next step may be step 510.

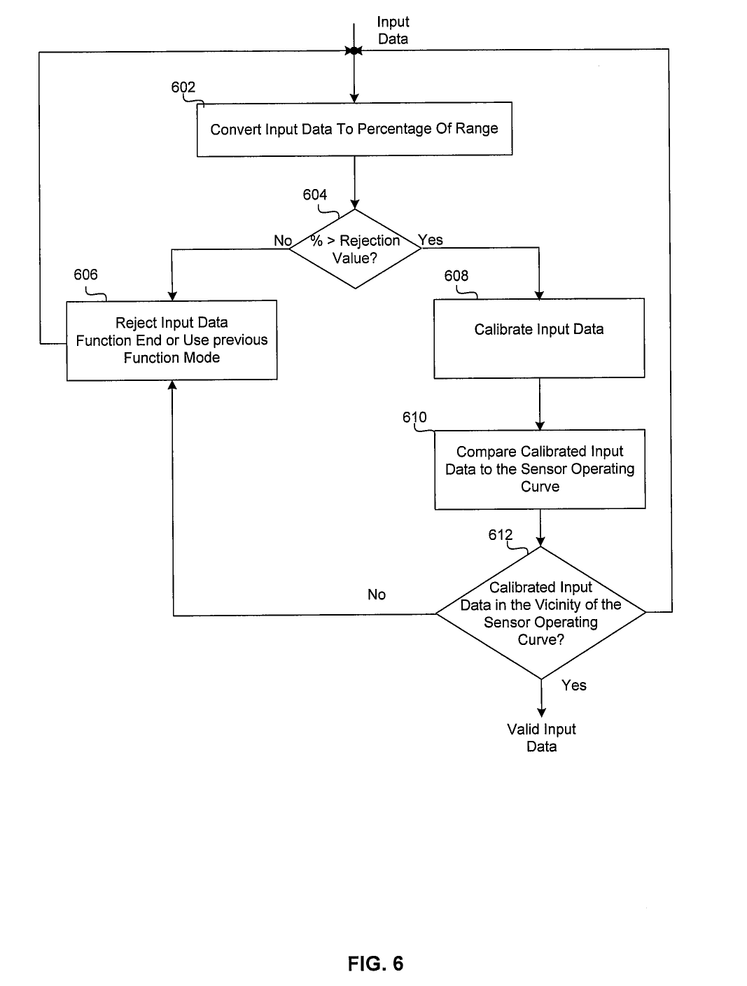

FIG. 6 is a flow chart that illustrates exemplary steps for determining valid input in a MEMS sensing and processing module, in accordance with an embodiment of the invention. Referring to FIG. 6, input data may be detected by one or more component sensor(s), sensing member(s) or sensing segment(s) in the MEMS detector 212. In step 602, the input data value may be converted to a percentage of the range of the component sensor(s), sensing member(s) or sensing segment(s). In step 604, the converted input value may be compared to a threshold rejection value. In this regard, it may be determined whether the percentage of range is greater than the rejection value. In instances where the percentage of range may be greater than the rejection value, then in step 608, the input data may be calibrated based on the range information of the component sensor(s), sensing member(s) or sensing segment(s) of the detector. For example, one brand new sensor, sensing member or sensing segment may come with a range in [0,100], and the maximum range is 100. After a period of usage, due to, for example, fatigue, the range of the component sensor, sensing member or sensing segment may [0, 80], and the maximum range is 80. The calibrated input data for the range 80 may be mapped back to its original value for the range 100. In step 610, the calibrated input data may be compared to a sensor(s), sensing member(s) or sensing segment(s) operating curve. In step 612, it may be determined whether the calibrated input data is in the vicinity of the sensor(s), sensing member(s) or sensing segment(s) operating curve. In instances where the calibrated input data may be in the vicinity of the sensor(s), sensing member(s) or sensing segment(s) operating curve, it may be determined that the input data is valid. In step 612, if it is determined that the input data may be invalid, then in step 606, the input data may be rejected. In this regard, previous function mode such as scrolling may be used or the function mode may be ended. After step 612, the exemplary steps may continue to step 602 to process the next input data. Returning to step 604, if the percentage of range is not greater than the rejection value, then in step 606, the input data may be rejected and the function may end or a previous function mode utilized.

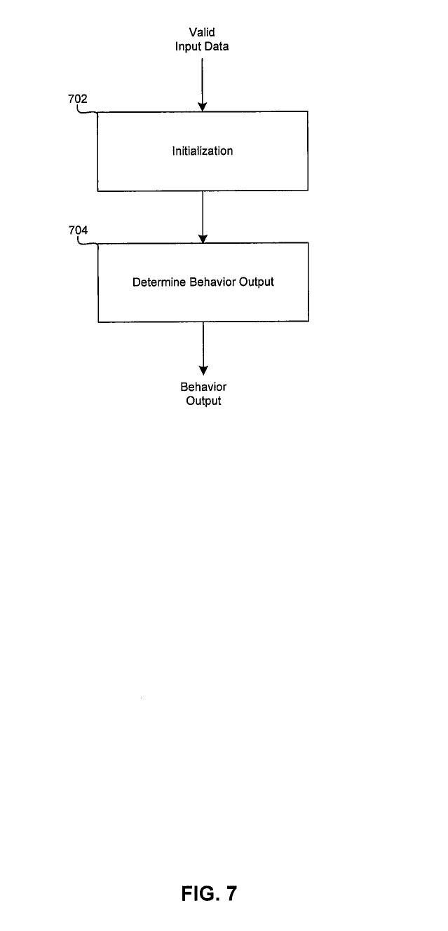

FIG. 7 is a flow chart that illustrates exemplary steps for determining behavior output in a MEMS sensing and processing module, in accordance with an embodiment of the invention. Referring to FIG. 7, valid input data may be received from various component sensor(s), sensing member(s) or sensing segment(s) in the MEMS detector 212. In step 702, initialization may occur. Accordingly, the input valid data may be checked to select desired valid input data in order to avoid unwanted or invalid input data. In this regard, various criteria may be applied to categorize the valid input data. For example, in instances where the MEMS detector 212 may comprise 4 sensors or detectors, the input valid data may comprise information on the changes in signals simultaneously at three or more sensors, then, potential human interactive output may not be processed. When unwanted input may be received, the process may be halted until the next valid set if input data is received. When desired valid input data may be received, then in step 704, the behavior output may be determined based on the wanted input valid data. Various algorithms and/or AI logic may be used to decide the behavior output.

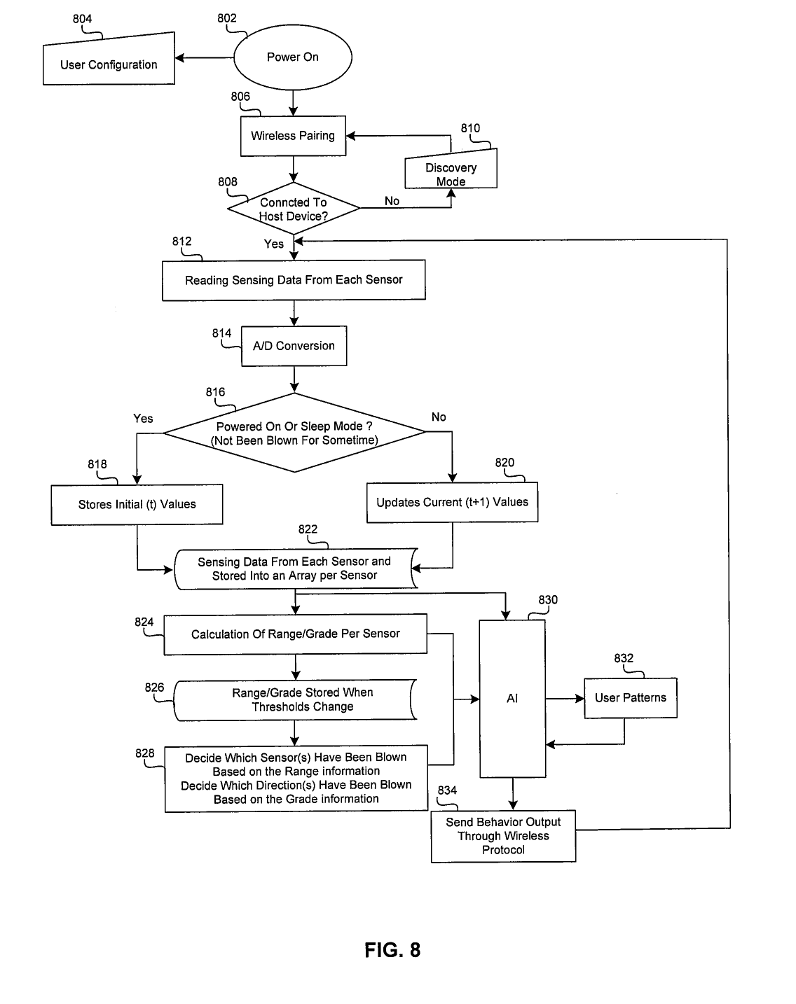

FIG. 8 is a flow chart that illustrates exemplary steps for human interaction of a wireless MEMS sensing and processing module, in accordance with an embodiment of the invention. Referring to FIG. 8, the exemplary steps may begin in step 802, where the user may turn on the MEMS sensing and processing module 104 with a wireless communication module 220, for example, Bluetooth. In step 804, user configuration may be applied by setting a variety of parameters such as, for example, time thresholds, intensity values, and interactive behavior. The interactive behavior may be, for example, a short puff of air for a click, a direction for a particular action, and/or a preferred blown pattern. Exemplary power saving related parameters such as, for example, sensor idle or sleep intervals, and sensor power turn on and off frequencies, may be also selected during the user configuration.

In step 806, pairing may be done and some user interaction may be required for wireless paring. In step 808, it may be determined whether there is a connection between the MEMS sensing and processing module 104 and the host device. In this regard, a connection status of the wireless paring may be checked. If there is no connection between the MEMS sensing and processing module 104 and the host device, then in step 810 discovery mode is entered. Wireless pairing may then be done in step 806. In instances where the wireless MEMS sensing and processing module 104 may be connected to the host device such as a phone, then in step 812, the MEMS detector 212 in the wireless MEMS sensing and processing module 104 may be enabled to read sensed data from each component sensor(s), sensing member(s) or sensing segment(s). In step 814, the sensed data may be converted into corresponding digital data.

In step 816, it may be determined whether the component sensor(s), sensing member(s) or sensing segment(s) is powered on or in sleep mode. The component sensor(s), sensing member(s) or sensing segment(s) may be in sleep mode if some time has elapsed without a puff of air from a user or other expulsion of air from other sources such as a device being detected. If the component sensor(s), sensing member(s) or sensing segment(s) is not powered on and not in sleep mode, then in step 820, the read values are updated for the current time instant. If the component sensor(s), sensing member(s) or sensing segment(s) is powered on or in sleep mode, for example, in instances where the component sensor(s), sensing member(s) or sensing segment(s) may not have been activated such as being blown for a while, then in step 818, at the beginning the interaction, the current value may be stored. Subsequent to step 818 and step 820, step 822 may be executed.

In step 822, sensed data from each sensor may be stored in an array for each component sensor, sensing member or sensing segment. Step 824 and/or step 830 may follow step 822. In step 824, calculation of range and/or grade may be done for each of the sensors or detectors. In step 826, the results of the calculated range and/or gradient for each sensor or detector may be stored when corresponding thresholds change. In step 828, the calculated sensor ranges and sensor grades may help to determine which component sensor(s), sensing member(s) or sensing segment(s) of the MEMS detector 212 were being blown or otherwise activated, and which directions the most blown may happen. For example, the highest portions in sensor ranges may decide which sensors or segments of the MEMS detector 212 may have been blown. The highest portions in sensor grades or gradient may be utilized to determine a particular direction for the fluid flow such as air flow. In the latter case, this may be the direction in which air was blown by a user, for example. Corresponding outputs or results from steps 822, 921 and/or step 828 may be inputs to steps 830. In step 830, inputs from steps 822, 824 and/or step 828 may be processed via artificial intelligence (AI) logic. In step 832, user behavior pattern resulting from step 830 may be stored and/or communicated or fed back to step 830. In step 834, behavior output resulting from execution of step 830 may be utilized communicated through, for example, a wireless protocol, where it may be utilized to enhance subsequent reading of sensed data.

Aspects of a method and system for processing signals for a MEMS detector 212 that enables control of a device using expulsion of air, for example, via human breath or a machine or a device are provided. In accordance with various embodiments of the invention, the microprocessor 214 may receive one or more signals from the MEMS detector 212 comprising various component sensor(s), sensing member(s) or sensing segment(s). The one or more component sensors, sensing members or sensing segments in the MEMS detector 212 may be enabled to detect movement of air caused by the expulsion of human breath. The signals may be processed by the microprocessor 214 and an interactive output comprising one or more control signals that may enable control of a user interface such as 107a on the multimedia device 106a may be generated. The processing may utilize one more steps disclosed, for example, with respect to one or more of FIG. 3 through FIG. 8.

For each component sensor, sensing member or sensing segment in the MEMS detector 212, ranges or gradients may be measured and evaluated to determine which of the one or more sensors, sensing members or sensing segments of the MEMS detector 212 may have been blown or deflected as disclose, for example, in steps 824, 826 and 828 in FIG. 8. The received signals may be in an analog format and may be converted into digital signals and further converted into integer values from, for example, a 10-bit number, as shown, for example, in the steps 404, 406, and 408 in FIG. 4 as well as in the step 814 in FIG. 8. The converted integer values may be stored, for example, in arrays. The component sensor(s), sensing member(s) or sensing segment(s) of the MEMS detector 212 may be calibrated as described with respect to FIG. 5. Depending on implementation and/or applications, in various exemplary embodiments of the invention, the component sensor(s), sensing member(s) or sensing segment(s) of the detector 212 may be calibrated statically or dynamically, calibrated at reset, or calibrated in each or every other couple sensor cycles. The one or more component sensors, sensing members or sensing segments of the MEMS detector 212 may be calibrated by calculating sensor ranges or sensor grades depending on applications. The calculated sensor ranges and sensor grades may be utilized to determine which component sensor(s), sensing member(s) or sensing segment(s) of the MEMS detector 212 may be blown or deflected, and a direction in which they were blown or deflected. To avoid unwanted interaction, a validity check may be applied to the input signals by the microprocessor 214.

In one exemplary embodiment of the invention, only valid input signals may be processed as potential interactive outputs. Notwithstanding, the invention is not so limited and other input signals may be utilized. The resulting interactive output may be translated to compatible interactive instructions within, for example, the user interface 107a. The interactive output may be communicated in a known format such as USB to the communication module 220 via wired or wireless communication such as Bluetooth, ZigBee and/or IR. The communication module 220 may communicate the received interactive output, which may comprise, for example host device user interface control information, to a host device such as, for example, the multimedia device 106a. Communication may occur via a wired and/or a wireless medium depending on the type of the communication module 220. The operation pattern of the MEMS may be stored and may be used to determine desired and/or undesirable interactive response. In accordance with an embodiment of the invention, the received signals may be formatted to be human interface device (HID) profile compliant. The formatted control signals may be communicated to the multimedia device 106a via a wired and/or wireless medium.

It is to be understood that the component sensor(s), sensing member(s) or sensing segment(s) may be in the form of MEMS technology enabled sensors. However, other types of sensor(s), sensing member(s) or sensing segment(s) may be utilized to detect the kinetic energy associated with the expulsion of air are also within the scope of the present invention. It should also be understood that the terms sensor(s), sensing member(s) or sensing segment(s) may be referred to individually or collectively as a detector or one or more detectors.

Another embodiment of the invention may provide a machine-readable storage, having stored thereon, a computer program having at least one code section executable by a machine, thereby causing the machine to perform the steps as described herein for processing signals for a MEMS detector that enables control of a device using human breath.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
receiving one or more signals from a MEMS module detector operable to detect movement of air caused by the expulsion of human breath;
processing in said MEMS module said received one or more signals; and
generating in said MEMS module one or more control signals that enable control of a user interface on a device based on said processing.

2. The method according to claim 1, wherein said movement of air causes deflection or movement of one or more members or segments of said MEMS module detector.

3. The method according to claim 1, comprising converting in said MEMS module said one or more signals from an analog format to a digital formatted data.

4. The method according to claim 3, comprising converting in said MEMS module said digital formatted data to corresponding integer values.

5. The method according to claim 4, comprising storing said one converted corresponding integer values.

6. The method according to claim 1, comprising calibrating said MEMS module detector.

7. The method according to claim 4, wherein said calibration of said MEMS module detector is done statically or dynamically.

8. The method according to claim 1, comprising determining whether said one or more received signals comprises a valid signal.

9. The method according to claim 1, comprising determining in said MEMS module a range of movement of one or more deflectable or moveable members or segments of said MEMS module detector.

10. The method according to claim 1, comprising determining in said MEMS module a gradient associated with movement of one or more deflectable or moveable members or segments of said MEMS module detector.

11. The method according to claim 1, comprising determining in said MEMS module a direction associated with movement of one or more deflectable or moveable members or segments of said MEMS module detector.

12. The method according to claim 1, comprising translating in said MEMS module said determined direction to a corresponding directional movement within said user interface.

13. The method according to claim 1, comprising formatting in said MEMS module said one or more control signals.

14. The method according to claim 13, comprising formatting said MEMS module said received one or more signals for a human interface device (HID) profile.

15. The method according to claim 13, comprising communicating from said MEMS module said formatted one or more control signals to said device via one or both of a wired or wireless medium.

16. The method according to claim 1, comprising processing in said MEMS module said received one or more signals based on a prior and/or current operation of said MEMS module detector.

17. A machine-readable storage having stored thereon, a computer program having at least one code section for signal processing, the at least one code section being executable by a machine for causing the machine to perform steps comprising:
receiving one or more signals from a MEMS module detector operable to detect movement of air caused by the expulsion of human breath;
processing in said MEMS module said received one or more signals; and
generating in said MEMS module one or more control signals that enable control of a user interface on a device based on said processing.

18. The machine-readable storage according to claim 17, wherein said movement of air causes deflection or movement of one or more members or segments of said MEMS module detector.

19. The machine-readable storage according to claim 17, wherein said at least one code section comprises code for converting in said MEMS module said one or more signals from an analog format to a digital formatted data.

20. The machine-readable storage according to claim 19, wherein said at least one code section comprises code for converting in said MEMS module said digital formatted data to corresponding integer values.

21. The machine-readable storage according to claim 20, wherein said at least one code section comprises code for storing in said MEMS module said one converted corresponding integer values.

22. The machine-readable storage according to claim 17, wherein said at least one code section comprises code for calibrating in said MEMS module said MEMS module detector.

23. The machine-readable storage according to claim 20, wherein said calibration of said MEMS detector is done statically or dynamically.

24. The machine-readable storage according to claim 17, wherein said at least one code section comprises code for determining in said MEMS module whether said one or more received signals comprises a valid signal.

25. The machine-readable storage according to claim 17, wherein said at least one code section comprises code for determining in said MEMS module a range of movement of one or more deflectable or moveable members or segments of said MEMS module detector.

26. The machine-readable storage according to claim 17, wherein said at least one code section comprises code for determining in said MEMS module a gradient associated with movement of one or more deflectable or moveable members or segments of said MEMS module detector.

27. The machine-readable storage according to claim 17, wherein said at least one code section comprises code for determining in said MEMS module a direction associated with movement of one or more deflectable or moveable members or segments of said MEMS module detector.

28. The machine-readable storage according to claim 17, wherein said at least one code section comprises code for translating in said MEMS module said determined direction to a corresponding directional movement within said user interface.

29. The machine-readable storage according to claim 17, wherein said at least one code section comprises code for formatting in said MEMS module said one or more control signals.

30. The system according to claim 29, wherein said at least one code section comprises code for formatting in said MEMS module said received one or more signals for a human interface device (HID) profile.

31. The machine-readable storage according to claim 29, wherein said at least one code section comprises code for communicating from said MEMS module said formatted one or more control signals to said device via one or both of a wired or wireless medium.

32. The machine-readable storage according to claim 17, wherein said at least one code section comprises code for processing in said MEMS module said received one or more signals based on a prior and/or current operation of said MEMS detector.

33. A system for signal processing, the system comprising:
one or more processors in a MEMS module, operable to receive one or more signals from a MEMS module detector, said MEMS module detector operable to detect movement of air caused by the expulsion of human breath;
said one or more processors enables processing of said received one or more signals; and
said one or more processors enable generation of one or more control signals that enable control of a user interface on a device based on said processing.

34. The system according to claim 33, wherein said movement of air causes deflection or movement of one or more members or segments of said MEMS module detector.

35. The system according to claim 33, wherein said one or more processors enables conversion of said one or more signals from an analog format to a digital formatted data.

36. The system according to claim 35, wherein said one or more processors enables conversion of said digital formatted data to corresponding integer values.

37. The system according to claim 36, wherein said one or more processors enables storage of said one converted corresponding integer values.

38. The system according to claim 33, wherein said one or more processors enables calibration of said MEMS module detector.

39. The system according to claim 4, wherein said calibration of said MEMS module detector is done statically or dynamically.

40. The system according to claim 33, wherein said one or more processors enables determination of whether said one or more received signals comprises a valid signal.

41. The system according to claim 33, wherein said one or more processors enables determination of a range of movement of one or more deflectable or moveable members or segments of said MEMS module detector.

42. The system according to claim 33, wherein said one or more processors enables determination of a gradient associated with movement of one or more deflectable or moveable members or segments of said MEMS module detector.

43. The system according to claim 33, wherein said one or more processors enables determination of a direction associated with movement of one or more deflectable or moveable members or segments of said MEMS module detector.

44. The system according to claim 43, wherein said one or more processors enables translation of said determined direction to a corresponding directional movement within said user interface.

45. The system according to claim 43, wherein said one or more processors enables formatting of said one or more control signals.

46. The system according to claim 45, wherein said one or more processors enables formatting of said received one or more signals for a human interface device (HID) profile.

47. The system according to claim 45, wherein said one or more processors enables communication of said formatted one or more control signals to said device via one or both of a wired or wireless medium.

48. The system according to claim 33, wherein said one or more processors enables processing of said received one or more signals based on a prior and/or current operation of said MEMS module detector
